(19) United States
(12) Patent Application Publication
(10) Pub. No.: US 2025/0198475 A1
(43) Pub. Date: Jun. 19, 2025

(54) SPRING MODULE CONFIGURED TO BE COMPRESSED FOR STORAGE, ELASTIC MODULE, AND ELASTIC MATTRESS

(71) Applicant: Luhao LENG, Xiamen (CN)

(72) Inventor: Luhao LENG, Xiamen (CN)

(21) Appl. No.: 18/974,895

(22) Filed: Dec. 10, 2024

(30) Foreign Application Priority Data
Dec. 14, 2023 (CN) 202311720556.3
Apr. 8, 2024 (CN) 202410412569.2

(51) Int. Cl. F16F 1/02; A47C 27/06; A47C 27/07

(52) U.S. Cl. CPC F16F 1/024; A47C 27/064; A47C 27/07; F16F 2230/0041; F16F 2230/105

(57) ABSTRACT

A spring module configured to be compressed for storage, the spring module includes an upper cover, a base and a spring disposed between the upper cover and the base; a lower end surface of the upper cover includes a first locking structure, and an upper end the base includes a second locking structure; the first locking structure and the second locking structure reach a locked position to be buckled together in a direction opposite to the opposite movement by an external force; and the first locking structure and the second locking structure in a locked state release from being buckled together by the external force.

### RELATED APPLICATIONS

This application claims priority to Chinese patent application number 202311720556.3, filed on Dec. 14, 2023, and Chinese patent application number 202410412569.2, filed on Apr. 8, 2024. Chinese patent application number 202311720556.3 and Chinese patent application number 202410412569.2 are incorporated herein by reference.

### FIELD OF THE DISCLOSURE

The present disclosure relates to the field of furniture, and in particular relates to a spring module configured to be compressed for storage, an elastic module, and an elastic mattress.

### BACKGROUND OF THE DISCLOSURE

Bed mattresses are essential furniture in beddings for human use in modern life. Elastic bed mattresses with a middle part having elastic components are becoming increasingly popular for relaxation during sleep, especially with increasing pressure in human lives. Most of the elastic components of the existing elastic bed mattress use springs packaged using independent bags. Each of the springs is individually packaged in one of a plurality of spring bags, the plurality of spring bags are then arranged in a pattern, and an arranged spring bag group is then covered with a whole piece of foam rubber to form the elastic bed mattress as a whole. This type of the elastic bed mattress cannot be disassembled and is not easy to transport. Therefore, bed mattresses in which the springs in the bed mattresses can be disassembled have been developed. However, the disassembled springs are always in released states during relocation and transportation, which occupies a lot of space and manpower for the relocation.

### BRIEF SUMMARY OF THE DISCLOSURE

The technical problem to be solved by the present disclosure is to provide a spring module configured to be compressed for storage, an elastic module, and an elastic mattress. When a disassembled spring module is relocated and transported, a space occupied by the spring module can be saved, and relocation and transportation efficiencies sped up.

In order to solve the aforementioned technical problems, the present disclosure provides a spring module configured to be compressed for storage. The spring module comprises a spring, an upper cover disposed on an upper end of the spring, and a base disposed on a lower end of the spring. The upper cover extends downward to define a first locking structure, and the base extends upward to define a second locking structure. The spring is compressed to a locked position along an axial direction of the spring by an external force, and the first locking structure and the second locking structure in the locked position are buckled together. The first locking structure and the second locking structure in a locked state move relative to each other in a circumferential direction of the spring to release from being buckled together.

In some embodiments, an upper end surface of the base comprises a protruding cavity structure along a compression direction of the spring module, an outer edge of the protruding cavity structure comprises protruding edges, which are discontinuous, as the second locking structure, and adjacent protruding edges of the protruding edges define gaps.

In some embodiments, a lower end surface of the upper cover comprises buckling hooks corresponding to the protruding edges one to one and disposed at intervals, the buckling hooks are used as the first locking structure, first surfaces of the protruding edges facing the base define positioning surfaces, and an opposite movement of the buckling hooks and the protruding edges along the axial direction of the spring enables the buckling hooks to be buckled to the positioning surfaces of the protruding edges so as to be buckled together in a direction opposite to the opposite movement to achieve buckling together.

In some embodiments, the buckling hooks and the protruding edges move relative to each other along the circumferential direction of the spring to enable the buckling hooks to reach the gaps to release from the buckling together.

In some embodiments, the protruding edges are gradually widened in a vertical downward direction, so that second surfaces of the protruding edges facing the upper cover define inclined surfaces, the buckling hooks comprise connecting portions and hook portions, first ends of the connecting portions are connected to the lower end surface of the upper cover, the hook portions are disposed on inner sides of the connecting portions and face a center of the protruding cavity structure, and the spring module is compressed to enable the hook portions to slide along the inclined surfaces of the protruding edges until the buckling hooks are buckled to the positioning surfaces to enable the buckling hooks to be buckled to the positioning surfaces.

In some embodiments, the protruding cavity structure comprises multiple layers of the protruding edges, which are discontinuous, along a vertical direction, and each of the multiple layers of the protruding edges is arranged at a same position on a circumference of the protruding cavity structure.

In order to solve the aforementioned technical problems, the present disclosure provides a spring module configured to be compressed for storage. The spring module comprises a spring, an upper cover disposed on an upper end of the spring, a base disposed on a lower end of the spring, and a releasing member. The upper cover extends downward to define a first locking structure, and the base extends upward to define a second locking structure. The spring is compressed to a locked position by an external force along an axial direction of the spring, and the first locking structure and the second locking structure in the locked position are buckled together. The releasing member is configured to drive a relative movement of the first locking structure and the second locking structure in a locked state in a radial direction of the spring to release the first locking structure and the second locking structure from buckling together.

In some embodiments, an upper end surface of the base comprises a protruding cavity structure along a compression direction of the spring module, an outer edge of the protruding cavity structure comprises a protruding edge, which is continuous, as the second locking structure, and a closing plug, used as the releasing member, is separably disposed in the protruding cavity structure and push the protruding edge to move relative to the first locking structure in the radial direction of the spring.

In some embodiments, a lower end surface of the upper cover comprises buckling hooks disposed at intervals and used as the first locking structure, a first surface of the protruding edge facing the base defines a positioning surface, and an opposite movement of the buckling hooks and the protruding edge along the axial direction of the spring enables the buckling hooks to be buckled to the positioning surface of the protruding edge so as to be buckled together in a direction opposite to the opposite movement to achieve the buckling together.

In some embodiments, the closing plug is taken out to enable the protruding edge to contract in the radial direction of the spring relative to the buckling hooks, and the buckling hooks are separated from the protruding edge to release the buckling together.

In order to solve the aforementioned technical problems, the present disclosure provides a spring module configured to be compressed for storage. The spring module comprises a spring, an upper cover disposed on an upper end of the spring, and a base disposed on a lower end of the spring. The upper cover extends downward to define a first locking structure, and the base extends upward to define a second locking structure. The spring is compressed to a locked position by an external force along an axial direction of the spring, and the first locking structure and the second locking structure in the locked position are buckled together. The first locking structure and the second locking structure in a locked state firstly move in the axial direction of the spring and then move in a circumferential direction of the spring relative to each other to release from buckling together by the external force.

In some embodiments, a lower end surface of the upper cover comprises a protruding cavity structure along a compression direction of the spring module, an inner wall of the protruding cavity structure extends towards a center of the protruding cavity structure to define protruding edges as the first locking structure, the protruding edges are disposed at intervals, and gaps are defined between the protruding edges.

In some embodiments, an upper end surface of the base comprises buckling hooks corresponding to the protruding edges one-to-one and disposed at intervals, the buckling hooks are used as the second locking structure, first surfaces of the buckling hooks facing the base define positioning surfaces, and an opposite movement of the buckling hooks and the protruding edges along the axial direction of the spring enables the protruding edges to be buckled to the positioning surfaces of the buckling hooks so as to be buckled together in a direction opposite to the opposite movement to achieve the buckling together.

In some embodiments, two sides of each of the protruding edges along a circumferential direction of the protruding cavity structure are respectively disposed with a first positioning wall and a second positioning wall located on the inner wall of the protruding cavity structure, an upper end surface of the first positioning wall is lower than an upper end surface of the second positioning wall, and the buckling hooks move in the axial direction of the spring and the circumferential direction of the spring relative to the protruding edges to reach the gaps to release from the buckling together by passing over the first positioning wall.

In some embodiments, a lower end surface of the first positioning wall is higher than a lower end surface of the second positioning wall, the lower end surface of the second positioning wall extends to a lower end surface of the protruding cavity structure, and a guiding inclined surface is connected to and disposed between the lower end surface of the first positioning wall and the lower end surface of the second positioning wall.

In some embodiments, a closing plug is separably disposed in a middle portion of the buckling hooks of the base, the closing plug is configured to push the buckling hooks to move in a radial direction of the spring, and when the closing plug is taken out: the buckling hooks contract in the radial direction of the spring relative to the protruding edges, and the buckling hooks are separated from the protruding edges to release the buckling together.

In order to solve the aforementioned technical problems, the present disclosure provides a spring module configured to be compressed for storage. The spring module comprises a spring, an upper cover disposed on an upper end of the spring, and a base disposed on a lower end of the spring. The upper cover extends downward to define a first locking structure, and the base extends upward to define a second locking structure. The spring is compressed to a locked position by an external force along an axial direction of the spring. When the spring is in the locked position, the first locking structure and the second locking structure move relative to each other in a circumferential direction of the spring by the external force, so that the first locking structure and the second locking structure are alternatively converted between a buckled state and an unbuckled state.

In some embodiments, a lower end surface of the upper cover comprises a first protruding cavity structure along a compression direction of the spring module, an end surface of the first protruding cavity structure comprises first protruding edges extending away from a center of the first protruding cavity structure, the first protruding edges are used as the first locking structure, and the first protruding edges are disposed at intervals.

In some embodiments, an upper end surface of the base comprises a second protruding cavity structure along the compression direction of the spring module, an upper end surface of the second protruding cavity structure comprises a surface having an opening, an inner wall of the surface having the opening comprises second protruding edges extending towards a center of the second protruding cavity structure, the second protruding edges are used as the second locking structure, the second protruding edges are disposed at intervals, and adjacent second protruding edges of the second protruding edges form gaps configured to enable the first protruding edges to pass through.

In some embodiments, after the first protruding edges are buckled to the second protruding cavity structure, the first protruding edges move relative to the second protruding edges in the circumferential direction of the spring enables the first protruding edges to be aligned with the second protruding edges, and the first protruding edges and the second protruding edges are buckled together in a direction opposite to an axial opposite movement to achieve buckling together.

In some embodiments, the first protruding edges and the second protruding edges move relative to each other in the circumferential direction of the spring to enable the first protruding edges to approach the gaps to release the second protruding edges from the buckling together.

In some embodiments, the first protruding edges and the second protruding edges respectively comprise one or more positioning grooves and one or more positioning protrusions for positioning cooperation.

In order to solve the aforementioned technical problems, the present disclosure provides a spring module configured to be compressed for storage. The spring module comprises a spring, an upper cover disposed on an upper end of the spring, and a base disposed on a lower end of the spring. The upper cover extends downward to define a first locking structure, and the base extends upward to define a second locking structure. The spring is compressed to a locked position by an external force along an axial direction of the spring, and the first locking structure and the second locking structure in the locked position are buckled together. The first locking structure and the second locking structure in a locked state move in the axial direction of the spring to release from buckling together by the external force.

In some embodiments, a lower end surface of the upper cover comprises a protruding cavity structure along a compression direction of the spring module, a top surface of the protruding cavity structure is open, an inner wall of the protruding cavity structure comprises a protruding edge, which is continuous, extending in a direction towards a center of the protruding cavity structure, and the protruding edge is used as the first locking structure.

In some embodiments, an upper end surface of the base comprises buckling hooks as the second locking structure, first surfaces of the buckling hooks facing the base define positioning surfaces, and an axial opposite movement of the protruding edge and the buckling hooks enables the protruding edge to be buckled to the positioning surfaces in a direction opposite to the axial opposite movement to achieve the buckling together.

In some embodiments, the buckling hooks have elasticity for contracting in a horizontal direction, the protruding cavity structure defines a pushing portion located on an upper side of the protruding edge, and the pushing portion moves in the axial direction of the spring to push the buckling hooks to contract inward in the horizontal direction, causing the buckling hooks and the protruding edge to be separated from each other to release from the buckling together.

In some embodiments, the buckling hooks are two buckling hooks, opposite sides of the two buckling hooks respectively comprise a pulling rib and a guiding groove, a first end of the pulling rib is used as a fixed end with a first one of the two buckling hooks, a second end of the pulling rib is disposed in the guiding groove used as a movable end, and the movable end moves in the guiding groove due to a compressing force for compressing the spring module.

In some embodiments, the guiding groove comprises an initial position, a first guiding surface, a half-way position, a second guiding surface, and a third guiding surface arranged in sequence, a distal end of the third guiding surface is in communication with the initial position, a one-way positioning surface is disposed between the initial position and the third guiding surface to enable the pulling rib to unidirectionally enter into the initial position from the third guiding surface, and the movable end is configured to stay at the initial position or the half-way position.

In some embodiments, a middle portion of the spring module is disposed with a connecting member, and an adjacent spring module is configured to be connected to the spring module through the connecting member.

In order to solve the aforementioned technical problems, the present disclosure provides an elastic module. The elastic module comprises multiple of the spring modules configured to be compressed for the storage, and the multiple of the spring modules are connected through a connecting member of each of the multiple of the spring modules to form the elastic module.

In order to solve the aforementioned technical problems, the present disclosure provides an elastic mattress, the elastic mattress comprises the elastic module.

Compared with the existing techniques, the technical solution has the following advantages. The first locking structure is disposed on a lower end of the upper cover of the spring module, and the second locking structure is disposed on the upper end surface of the base. The spring module is compressed to enable the first locking structure and the second locking structure to be buckled together to lock the spring module in the compressed state. The disassembled spring modules can be maintained in the compressed state, occupied spaced for relocation and transportation are saved, and labor costs are saved.

### BRIEF DESCRIPTION OF THE DRAWINGS

FIG. 1 is a perspective view of a spring module in embodiment 1 of the present disclosure;

FIG. 2 is a diagrammatic view of the spring module in embodiment 1 of the present disclosure with a part of a cloth sleeve being removed;

FIG. 3 is a perspective sectional view of the spring module in embodiment 1 of the present disclosure;

FIG. 4 is a front sectional view of the spring module in embodiment 1 of the present disclosure;

FIG. 5 is a diagrammatic view of the spring module after being compressed in embodiment 1 of the present disclosure;

FIG. 6 is a sectional view of the spring module after being compressed in embodiment 1 of the present disclosure;

FIG. 7 is a diagrammatic view of an unlocking method of the spring module in embodiment 1 of the present disclosure;

FIG. 8 is a perspective view of an elastic module formed by connecting spring modules together in embodiment 1 of the present disclosure;

FIGS. 9 and 10 are diagrammatic views of the spring modules that are compressed to be packaged in the elastic module in embodiment 1 of the present disclosure;

FIG. 11 is a diagrammatic view of the spring modules that are individually compressed and stacked in embodiment 1 of the present disclosure;

FIGS. 12-14 are diagrammatic views of the spring modules that are arranged in different arrays after being stacked in embodiment 1 of the present disclosure;

FIG. 15 is a diagrammatic view of a spring module in embodiment 2 of the present disclosure with a part of a cloth sleeve being removed;

FIG. 16 is a perspective sectional view of the spring module in embodiment 2 of the present disclosure;

FIG. 17 is a front sectional view of the spring module in embodiment 2 of the present disclosure;

FIGS. 18 and 19 are enlarged views of parts A and B in FIG. 17;

FIG. 20 is a diagrammatic view of the spring module after being compressed in embodiment 2 of the present disclosure;

FIGS. 21-23 are diagrammatic views of a process in which the spring module is compressed in embodiment 2 of the present disclosure;

FIG. 24 is a diagrammatic view of a spring module in embodiment 3 of the present disclosure with a part of a cloth sleeve being removed;

FIG. 25 is a perspective sectional view of the spring module in embodiment 3 of the present disclosure;

FIG. 26 is a front sectional view of the spring module in embodiment 3 of the present disclosure;

FIG. 27 and FIG. 28 are enlarged views of parts C and D in FIG. 26;

FIG. 29 is a diagrammatic view of the spring module after being compressed in embodiment 3 of the present disclosure;

FIGS. 30-32 are diagrammatic views of a process in which the spring module is released in embodiment 3 of the present disclosure;

FIG. 33 is a diagrammatic view of a spring module in embodiment 4 of the present disclosure with a part of a cloth sleeve being removed;

FIG. 34 is a perspective sectional view of the spring module in embodiment 4 of the present disclosure;

FIG. 35 is a front sectional view of the spring module in embodiment 4 of the present disclosure;

FIGS. 36 and 37 are enlarged views of parts E and F in FIG. 35;

FIG. 38 is a diagrammatic view of the spring module after being compressed in embodiment 4 of the present disclosure;

FIGS. 39-41 are diagrammatic views of a process in which the spring module is compressed in embodiment 4 of the present disclosure;

FIG. 42 is a diagrammatic view of a spring module in embodiment 5 of the present disclosure with a part of a cloth sleeve being removed;

FIG. 43 is a perspective sectional view of the spring module in embodiment 5 of the present disclosure;

FIG. 44 is a front sectional view of the spring module in embodiment 5 of the present disclosure;

FIGS. 45 and 46 are enlarged views of parts G and H in FIG. 44;

FIG. 47 is a diagrammatic view of the spring module after being compressed in embodiment 5 of the present disclosure;

FIGS. 48-50 are diagrammatic views of a process in which the spring module is compressed in embodiment 5 of the present disclosure; and

FIG. 51 is a diagrammatic view of a guiding groove in embodiment 5 of the present disclosure.

### DETAILED DESCRIPTION OF THE EMBODIMENTS

The technical solutions in the embodiments of the present disclosure will be described clearly and completely in combination with the accompanying drawings in the embodiments of the present disclosure. It is obvious that the described embodiments are merely some of the embodiments of the present disclosure rather than all of the embodiments, and all other embodiments fall within the scope of protection of the present disclosure provided that they are obtained based on the embodiments of the present disclosure by a person of ordinary skill in the art without creative works.

In the description of the present disclosure, it should be noted that terms, such as “upper”, “lower”, “inner”, “outer”, “top”, and “bottom”, indicate orientations or positional relationships based on orientations or positional relationships shown in the accompanying drawings. These terms are merely used to easily describe the present disclosure and simplify the description of the present disclosure, rather than indicating or implying that a referred device or element should have a particular orientation or be constructed and operated with a particular orientation, and therefore should not to be understood as a limitation of the present disclosure. Furthermore, the terms “first” and “second” are merely used for descriptive purposes and should not be understood as indicating or implying relative importance.

In the description of the present disclosure, unless otherwise expressly specified and limited, it is noted that terms, such as “mounted”, “provided with”, “socketed”, “sleeved”, and “connected”, should develop a broad understanding. For example, “connection” can be a wall-mountable connection, a detachable connection, a one-piece connection, a mechanical connection, an electrical connection, a direct connection, an indirect connection via an intermediate medium, or a communication between inner portions of two elements, and the specific meaning of the terms in the present disclosure can be understood in specific conditions for those of ordinary skill in the art.

### Embodiment 1

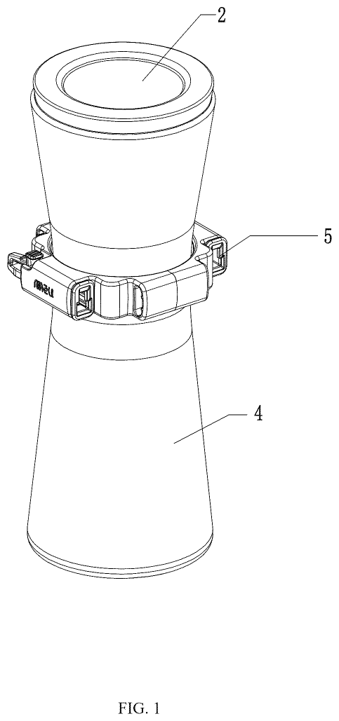

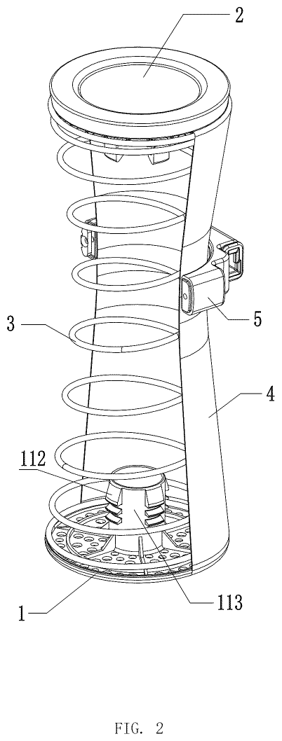

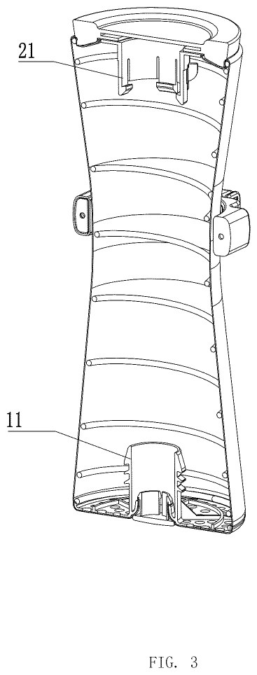

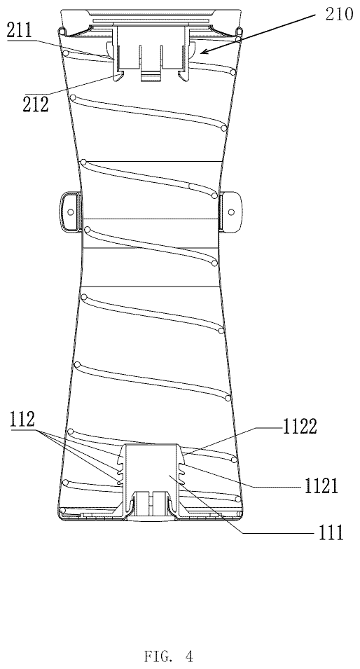

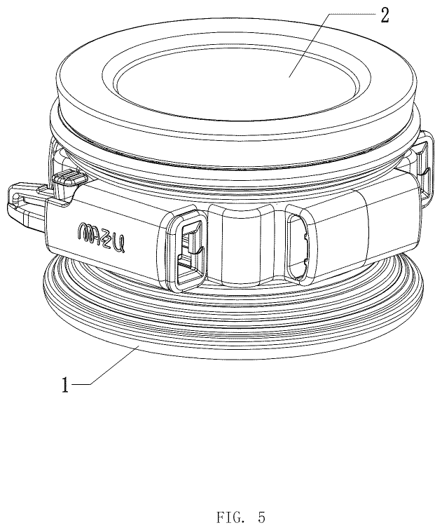

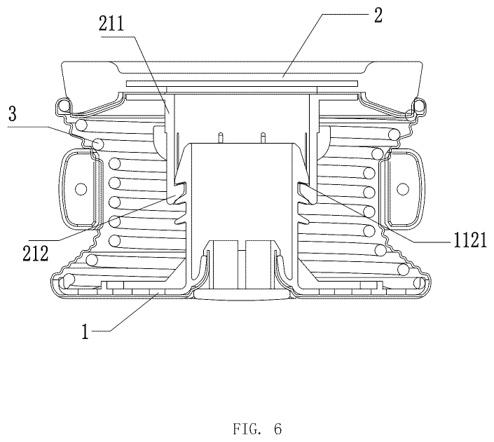

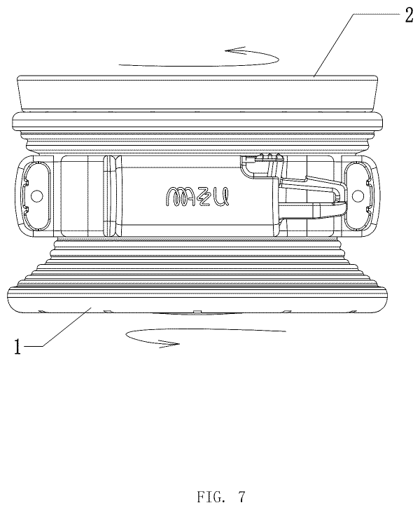

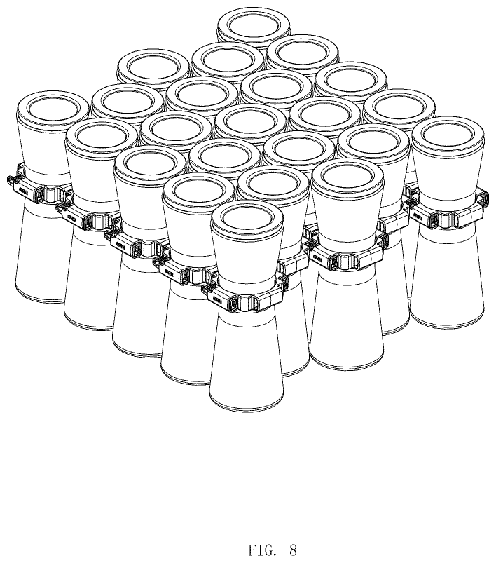

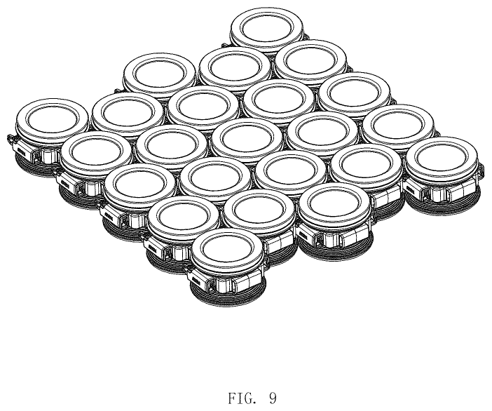

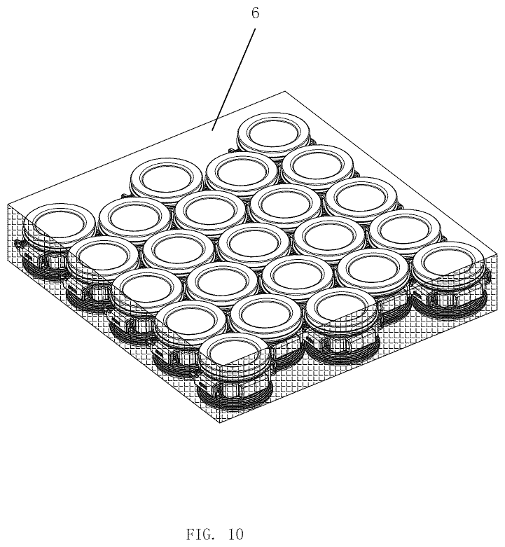

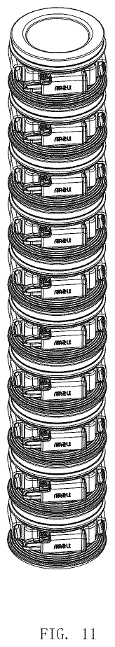

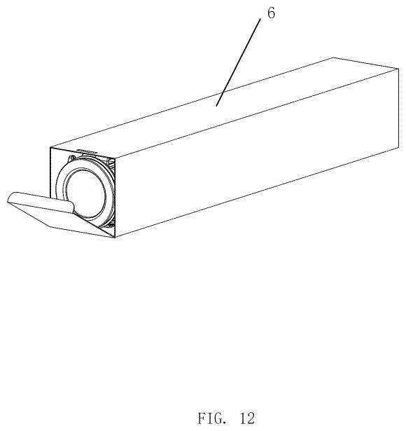

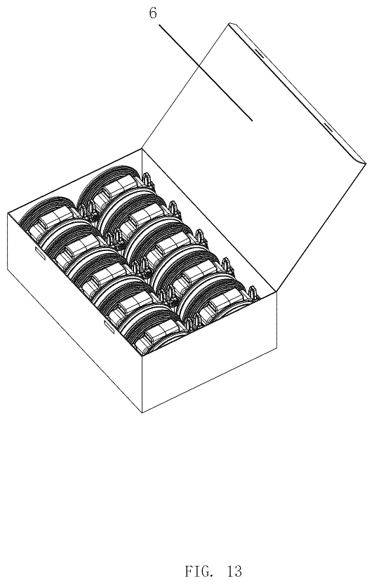

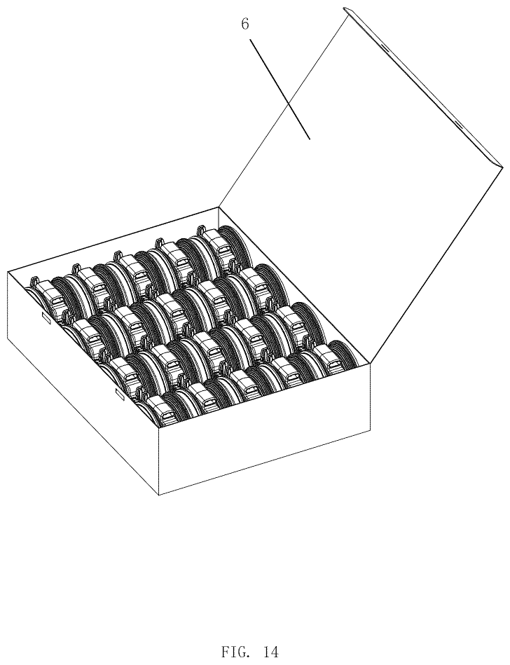

Referring to FIGS. 1-14, this embodiment provides a spring module configured to be compressed for storage. The spring module comprises a base 1 and an upper cover 2. A spring 3 is disposed between the base 1 and the upper cover 2, and an outer surface of the spring module is wrapped with a flexible cloth sleeve 4. A connecting member 5 is further disposed on a waist portion of the spring module, and adjacent spring modules are connected together to be spliced into an elastic module with a size required by the user through the connecting member 5. An outer side of the elastic module is wrapped with a decoration cloth, and the elastic module can be then used as an elastic mattress.

A lower end surface of the upper cover 2 comprises a first locking structure 21, and an upper end surface of the base 1 comprises a second locking structure 11. The first locking structure 21 and the second locking structure 11 face each other and are disposed in a chamber of the spring module. The spring module is compressed to enable the first locking structure 21 and the second locking structure 11 to be buckled together in a vertical direction to lock the spring module in a compressed state. The spring module rotates to release the first locking structure 21 from buckling to the second locking structure 11 so as to release the spring module from the compressed state.

Specifically, the upper end surface of the base 1 forms a protruding cavity structure 111, which has a cylindrical shape, along a compression direction of the spring module, and an outer edge of a top of the protruding cavity structure 111 comprises protruding edges 112, which are discontinuous, as the second locking structure 11. Gaps 113 are defined between adjacent protruding edges 112 of the protruding edges 112. The lower end surface of the upper cover 2 comprises buckling hooks 210 corresponding to the protruding edges 112 one to one and at intervals, and the buckling hooks 210 are used as the first locking structure 21.

First surfaces of the protruding edges 112 facing the base 1 form positioning surfaces 1121. The protruding edges 112 are gradually widened in a vertical downward direction to enable second surfaces of the protruding edges 112 facing the upper cover 2 to form inclined surfaces 1122. The buckling hooks 210 comprise connecting portions 211 and hook portions 212. Ends of the connecting portions 211 are connected to the lower end surface of the upper cover 2, and the hook portions 212 are disposed on inner sides of the connecting portions 211 and face a center of the protruding cavity structure 111.

When the spring module needs to be locked in the compressed state, the upper cover 2 and the base 1 are held by both hands to compress the spring module by a force. At this time, the buckling hooks 210 on the upper cover 2 slide along the inclined surfaces 1122 of the protruding edges 112, and the inclined surfaces 1122 enable the buckling hooks 210 to generate an acting force away from the center of the protruding cavity structure 111 to drive the buckling hooks 210 to extend. When the buckling hooks 210 slide downward to be separated from the inclined surfaces 1122, the buckling hooks 210 contract due to an elastic restoring force of the buckling hooks 210, causing the hook portions 212 to be buckled to the positioning surfaces 1121. At this time, the positioning surfaces 1121 of the protruding edges 112 are buckled to the buckling hooks 210 in a direction for releasing the spring module, thereby locking the spring module in the compressed state. The spring modules in the compressed state are stacked and loaded into a packaging box 6 to facilitate transportation. The spring modules in the compressed state can be stacked in the vertical direction and then be put into the packaging box 6 having an elongated shape. Alternatively, the spring modules in the compressed state can be stacked into the packaging box 6 in an arrangement, such as 1×10, 2×5, 4×5, for transportation. The spring modules that are packed into the packaging box 6 can be connected together through the connecting members 5, or the spring modules can be compressed to a locked state one by one and then put into the packaging box 6 for transportation.

The spring modules being maintained in the compressed state occupy less space, and more of the spring modules can be transported at one time, which is also convenient to relocate for the users and saves labor costs at this time.

When the spring module needs to be released for splicing, the spring module rotates to drive the buckling hooks 210 to be separated from the positioning surfaces 1121 of the protruding edges 112 to reach the gaps 113. At this time, the spring module in the compressed state drives the spring module to be in a released state by a restoring force, and the spring modules can be then assembled into the elastic module for use by the user through the connecting members 5. The aforementioned rotation of the spring module means that the upper cover 2 and the base 1 rotate in opposite directions, thereby resulting in a relative movement of the upper cover 2 and the base 1.

In order to adjust a compression height of the spring module, the protruding cavity structure 111 comprises multiple layers of the protruding edges 112 that are discontinuous along the vertical direction, and each of the multiple layers of the protruding edges 112 is disposed at a same position on a circumference of the protruding cavity structure 111. The buckling hooks 210 are compressed to be buckled to different layers of the multiple layers of the protruding edges 112, so that the compression height of the spring module can be adjusted.

### Embodiment 2

In the solution in Embodiment 1, as long as the base 1 and the upper cover 2 rotate relative to each other, the protruding edges 112 and the hook portions 212 will rotate relative to each other along a circumferential direction of the protruding cavity structure 111, causing the protruding edges 112 to be separated from the hook portions 212 for unlocking. Therefore, a locking structure of Embodiment 1 is not sufficiently stable and is prone to operational mistakes, resulting in the spring module being unlocked.

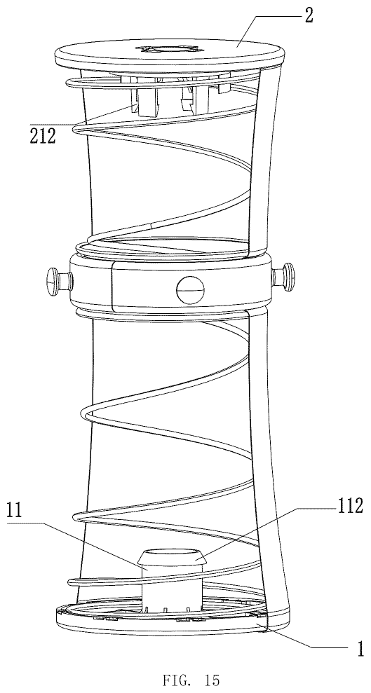

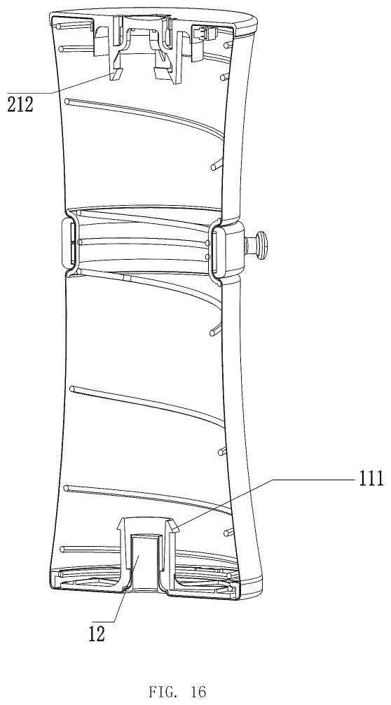

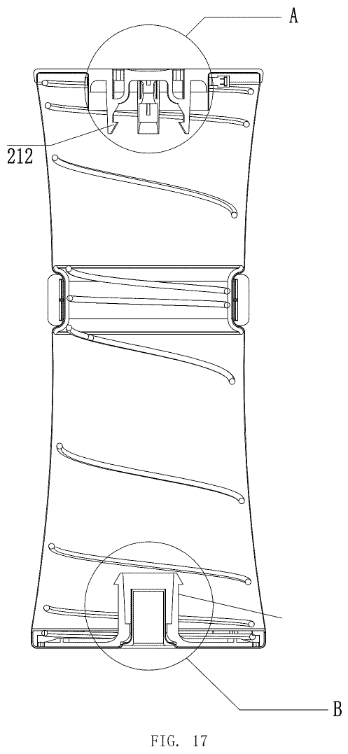

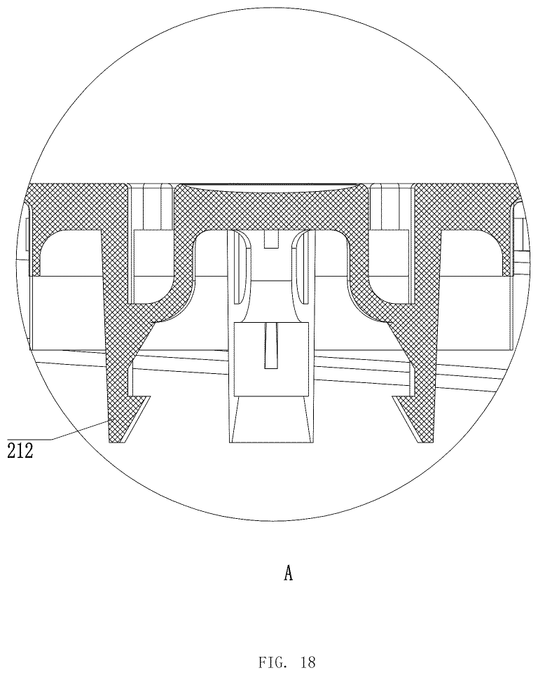

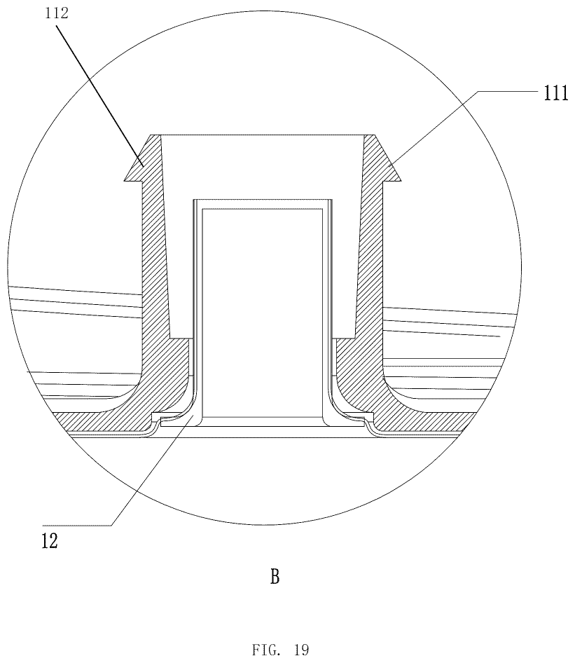

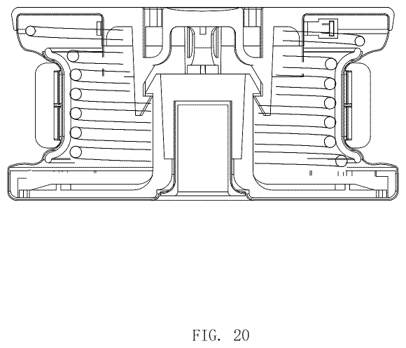

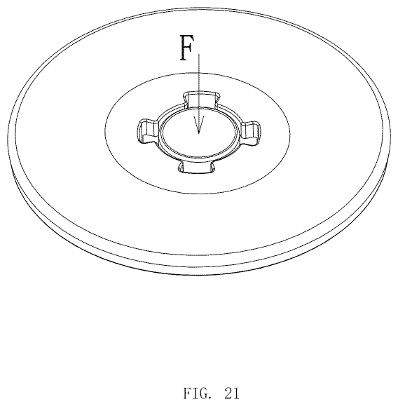

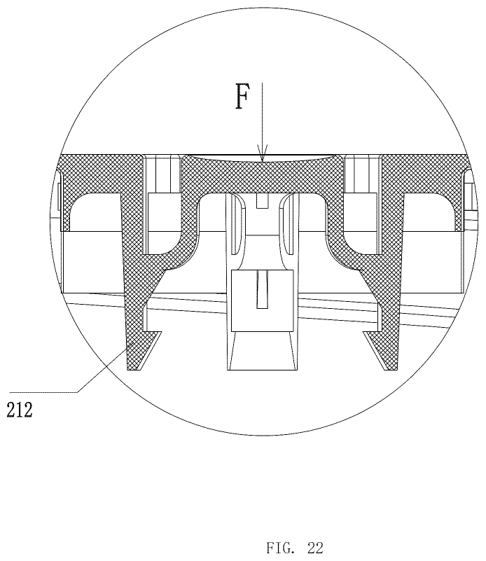

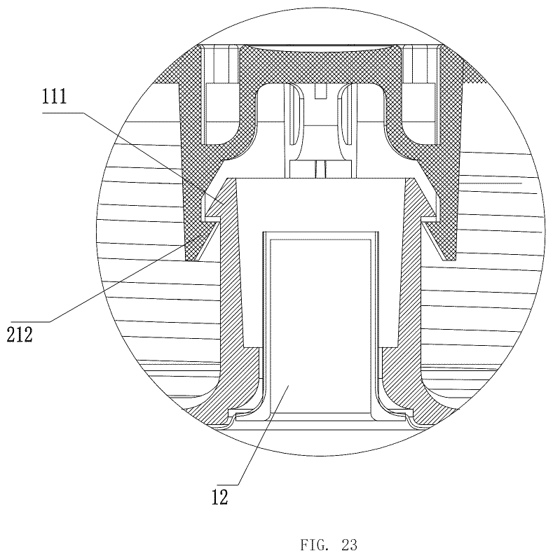

In order to enable a locked state of the locking structure to be more stable, referring to FIGS. 15-23, this embodiment differs from Embodiment 1 in that the protruding edges 112 of the second locking structure 11 in Embodiment 1 are discontinuous, while in Embodiment 2, a protruding edge 112 of the second locking structure 11 is continuously arranged. A structure of the first locking structure 21 is the same as that of Embodiment 1 and will not be described herein. As the protruding edge 112 is continuously arranged, it is impossible to rotate the spring module to drive a relative movement of the protruding edge 112 and the hook portions 212 along the circumferential direction of the protruding cavity structure 111 to separate the protruding edges 112 from the hook portions 212 for unlocking as in Embodiment 1. Therefore, even if the base 1 and the upper cover 2 rotate relative to each other, the spring module will not be released.

In order to achieve unlocking, in this embodiment, a closing plug 12 is disposed in a middle portion of the protruding cavity structure 111 of the base 1. When the closing plug 12 is installed in the base 1, the closing plug 12 can push the protruding edge 112 to extend outward along a radial direction of the protruding cavity structure 111. After taking out the closing plug 12, the protruding edge 112 will contract in a direction towards a center of a circle defined by the protruding cavity structure 111, thereby causing the protruding edge 112 to be separated from the hook portions 212. In this way, in this embodiment, relative movement of the protruding edge 112 and the hook portions 212 in the circumferential direction in Embodiment 1 is changed to a relative movement of the protruding edge 112 and the hook portions 212 in the radial direction. Eventually, the protruding edge 112 can be separated from the hook portions 212, thereby releasing the spring module.

### Embodiment 3

In the solution in Embodiment 1, as long as the base 1 and the upper cover 2 rotate relative to each other, the protruding edges 112 and the hook portions 212 will rotate relative to each other along a circumferential direction of the protruding cavity structure 111, causing the protruding edges 112 to be separated from the hook portions 212 for unlocking. Therefore, a locking structure of Embodiment 1 is not sufficiently stable, and operational mistakes are prone to happen, resulting in the spring module being unlocked. In the solution of Embodiment 2, as long as the closing plug 12 is taken out, the spring module will instantly release an elastic force, which is also prone to accidents.

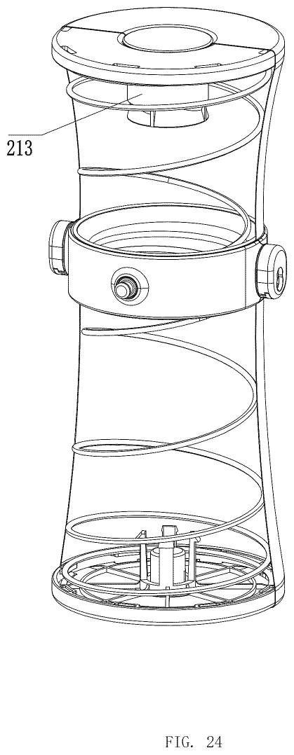

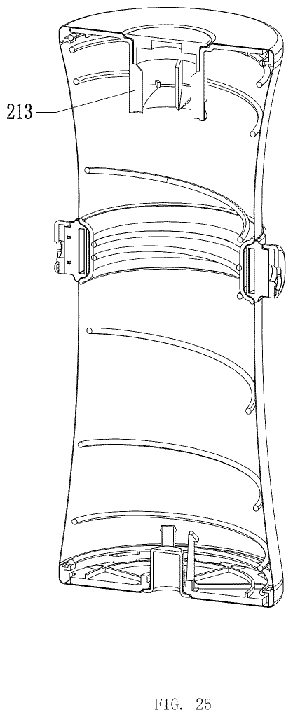

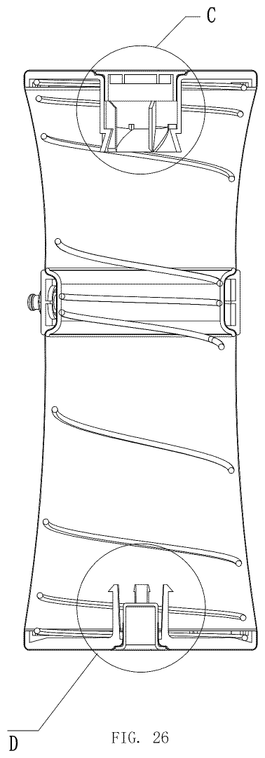

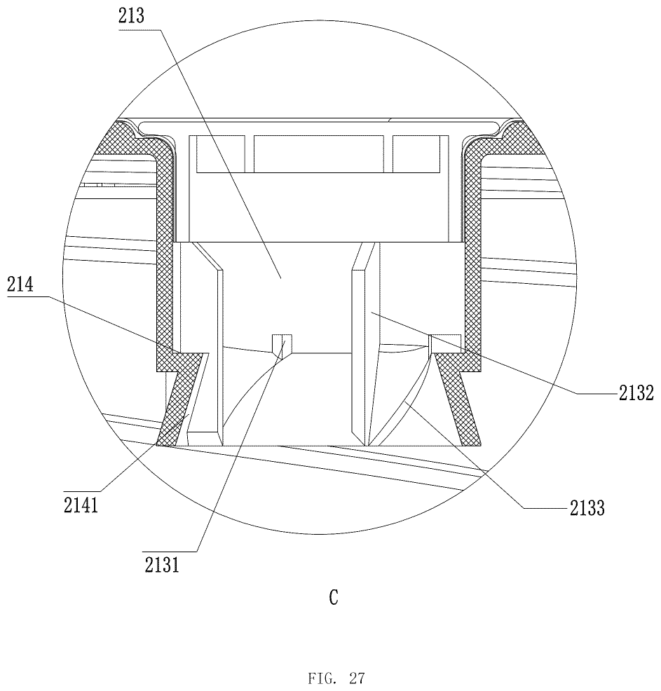

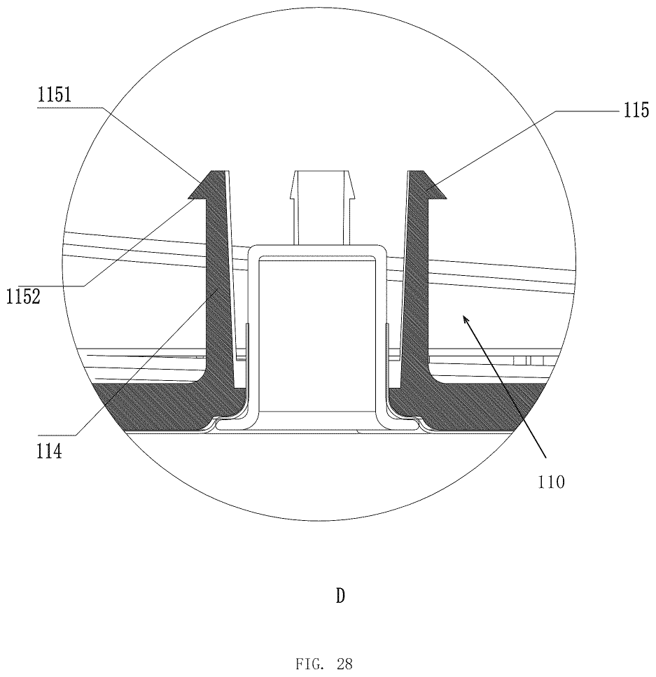

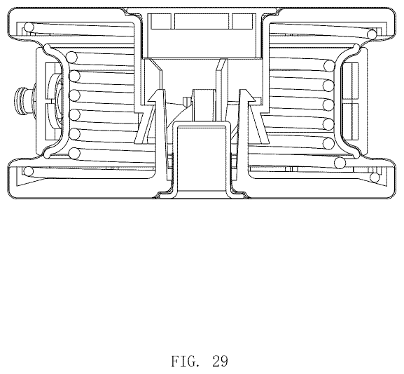

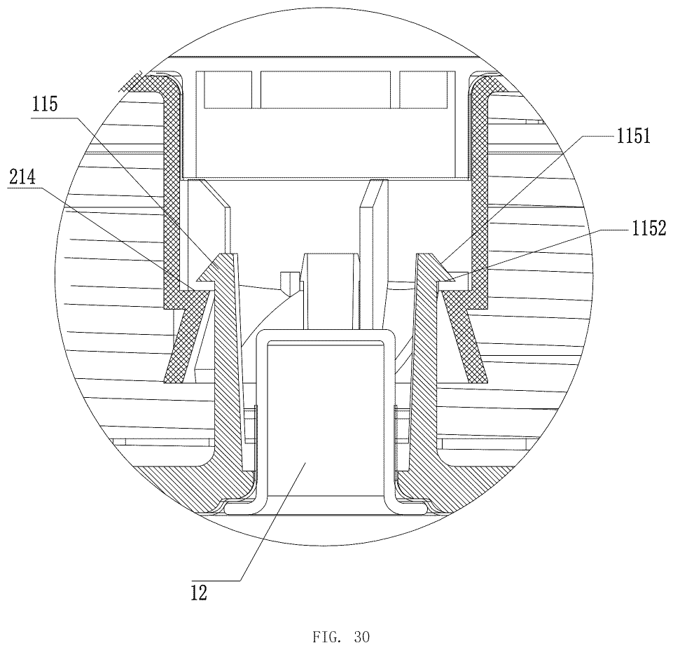

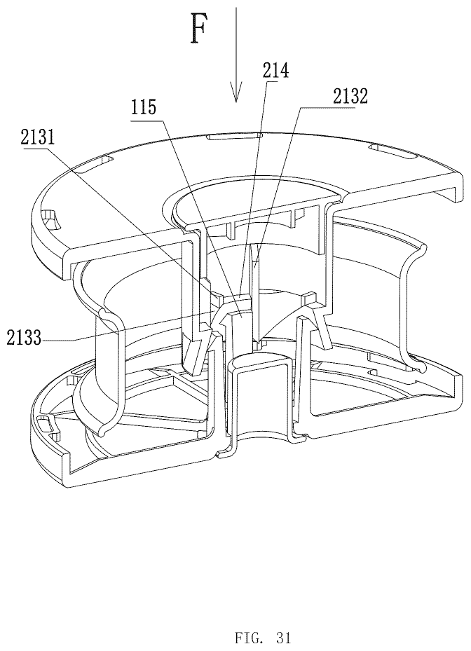

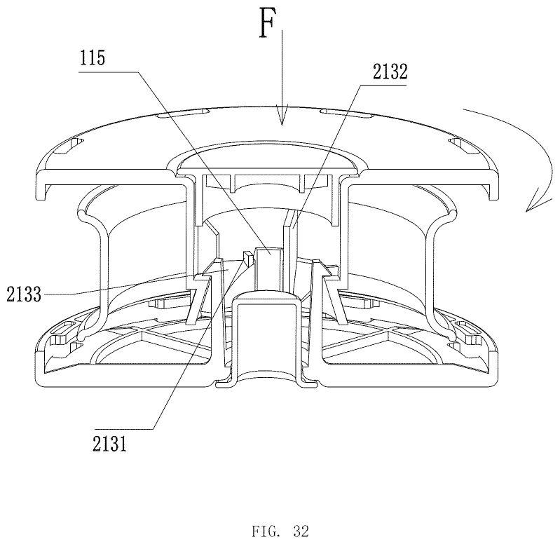

In order to enable a locked state of the locking structure to be more stable, referring FIGS. 24-32, in this embodiment, a lower end surface of the upper cover 2 comprises a protruding cavity structure 213 having a cylindrical shape along a compression direction of the spring module. An inner wall of the protruding cavity structure 213 extends towards a center of the protruding cavity structure 213 to define protruding edges 214 as the first locking structure 21, and the protruding edges 214 are disposed at intervals.

An upper end surface of the base 1 comprises buckling hooks 110 corresponding to the protruding edges 214 one to one and at intervals, and the buckling hooks 110 are used as the second locking structure 11. The buckling hooks 110 comprise connecting portions 114 and hook portions 115, and the hook portions 115 are disposed on outer sides of the connecting portions 114. The hook portions 115 are gradually widened in a vertical downward direction to enable first surfaces of the hook portions 115 facing the upper cover 2 to define first inclined surfaces 1151, and second surfaces of the hook portions 115 facing the base 1 define positioning surfaces 1152. In order to cooperate with the first inclined surfaces 1151 of the hook portions 115, lower surfaces of the protruding edges 214 define second inclined surfaces 2141.

In addition, an inner wall of the protruding cavity structure 213 comprises a first positioning wall 2131 and a second positioning wall 2132 respectively disposed on two sides of each of the protruding edges 214 along a circumferential direction. An upper end surface of the first positioning wall 2131 is lower than an upper end surface of the second positioning wall 2132, and a lower end surface of the first positioning wall 2131 is higher than a lower end surface of the second positioning wall 2132. The lower end surface of the second positioning wall 2132 extends to a lower end surface of the protruding cavity structure 213, and a spiral guiding inclined surface 2133 is connected to and disposed between the lower end surface of the first positioning wall 2131 and the lower end surface of the second positioning wall 2132.

When the spring module needs to be locked in a compressed state, the upper cover 2 and the base 1 are held by both hands to compress the spring module by a force. At this time, the protruding edges 214 on the upper cover 2 slide along the first inclined surfaces 1151 of the buckling hooks 110 to be then buckled to the positioning surfaces 1152 of the hook portions 115. The protruding edges 214 are buckled to the positioning surfaces 1152 of the hook portions 115 in a direction for releasing the spring module, thereby locking the spring module in the compressed state. The spring modules in the compressed state are then stacked and loaded into the packaging box 6 for facilitating transportation. At this time, since the two sides of each of the protruding edges 214 are respectively disposed with the first positioning wall 2131 and the second positioning wall 2132, the protruding edges 214 and the hook portions 115 cannot rotate relative to each other along the circumferential direction of the protruding cavity structure 213, thus ensuring stability of a locked state of the spring module.

When the spring module needs to be released for splicing, the spring module needs to be firstly further compressed, so that the hook portions 115 move upward relative to the first positioning walls 2131, thereby releasing a buckled connection of the first positioning walls 2131 and the hook portions 115 along the circumferential direction of the protruding cavity structure 213. Since heights of the second positioning walls 2132 are relatively high, the second positioning walls 2132 still form a buckled connection with the hook portions 115 along the circumferential direction. In this way, the hook portions 115 can merely rotate in a direction facing the first positioning walls 2131. When the hook portions 115 rotate to pass over the first positioning walls 2131, the user can release a force for compressing the spring module, the spring module releases an elastic restoring force to enable the hook portions 115 to abut the spiral guiding inclined surfaces 2133, and the hook portions 115 will move along the spiral guiding inclined surfaces 2133, thereby releasing the spring module. This method can not only achieve stability of the locked state, but an elastic releasing process is also prolonged, thereby avoiding accidents caused by the elastic restoring force of the elastic module being accumulated and released suddenly.

As in Embodiment 2, in this embodiment, the closing plug 12 is disposed in a middle portion of the buckling hooks 110 of the base 1, and the closing plug 12 is installed in the base 1 to push the buckling hooks 110 to extend outward along a radial direction. After the closing plug 12 is taken out, the buckling hooks 110 will contract towards a center of a circle defined by the buckling hooks 110, thereby causing the protruding edges 214 to be separated from the hook portions 115. In this way, in this embodiment, relative movement of the protruding edges 112 and the hook portions 212 in the circumferential direction in Embodiment 1 is converted into relative movement of the protruding edges 214 and the hook portions 115 in the radial direction. Eventually, the protruding edges 214 are separated from the hook portions 115, thereby releasing the spring module. That is, in this embodiment, in addition to unlocking by compressing and rotating the spring module, unlocking can also be performed by taking out the closing plug 12.

### Embodiment 4

In the solution in Embodiment 1, as long as the base 1 and the upper cover 2 rotate relative to each other, the protruding edges 112 and the hook portions 212 will rotate relative to each other along a circumferential direction of the protruding cavity structure 111, causing the protruding edges 112 to be separated from the hook portions 212 for unlocking. Therefore, the locking structure of Embodiment 1 is not sufficiently stable, and operational mistakes are prone to happen, resulting in the spring module being unlocked.

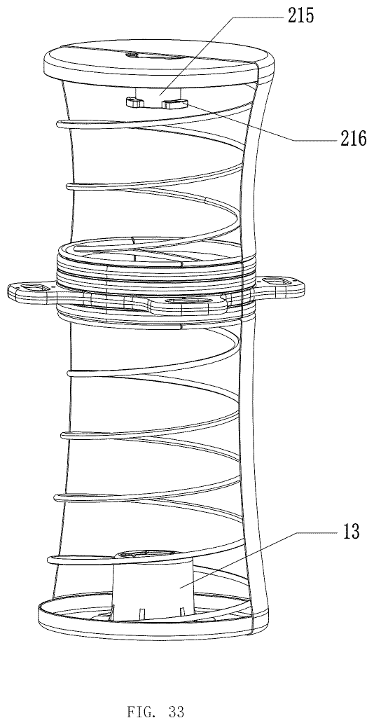

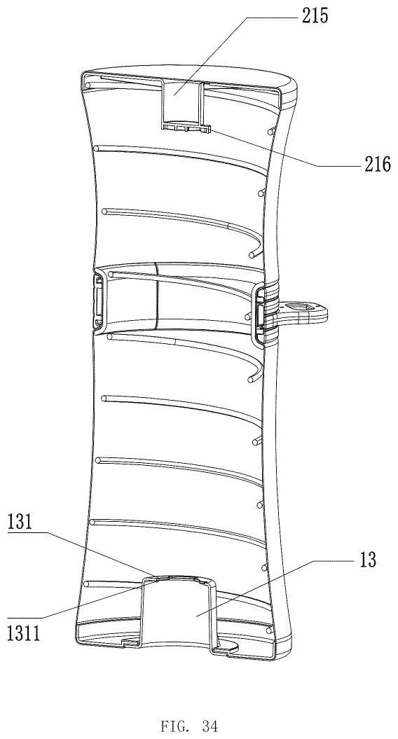

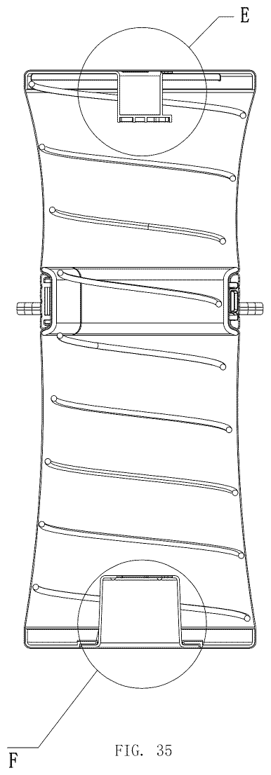

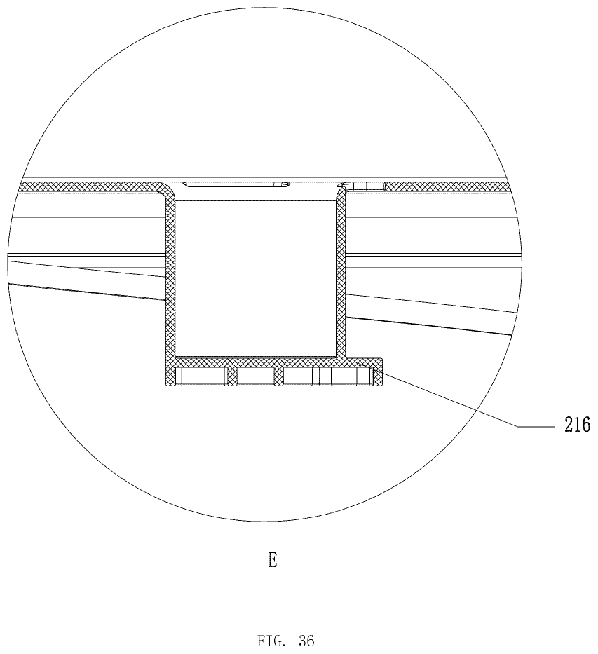

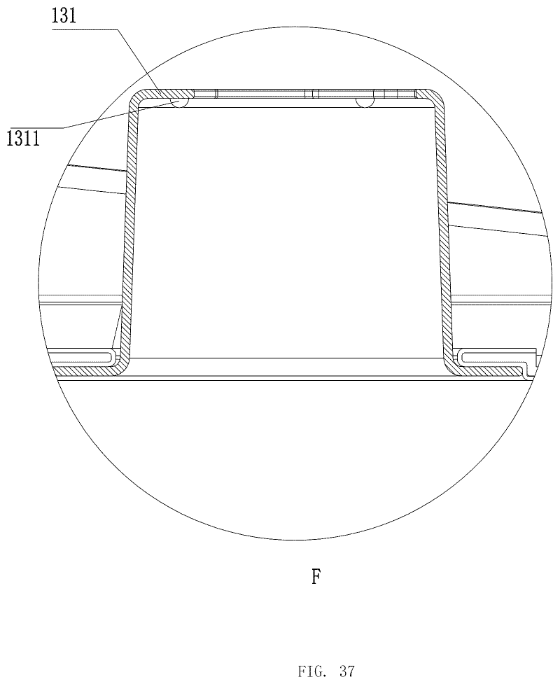

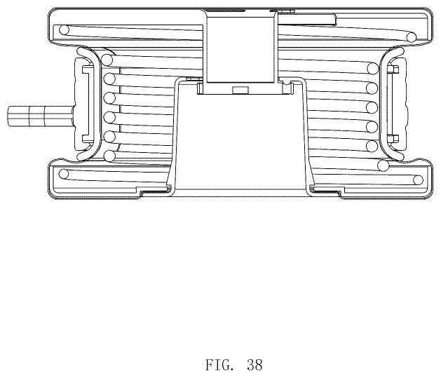

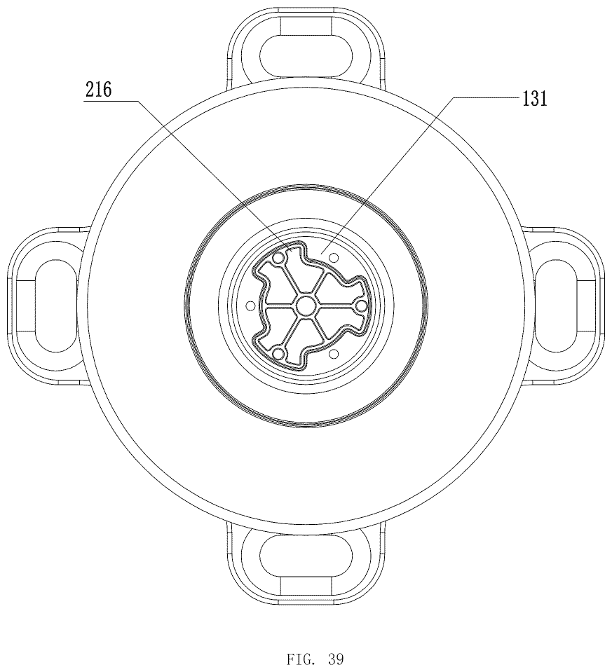

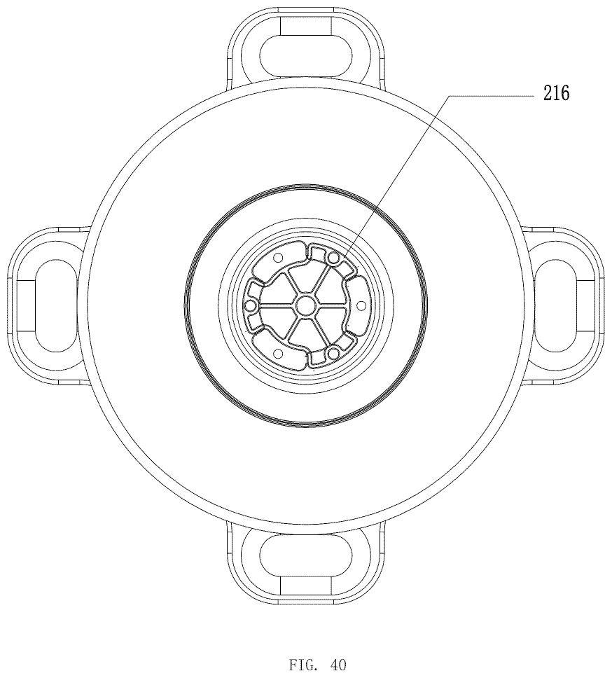

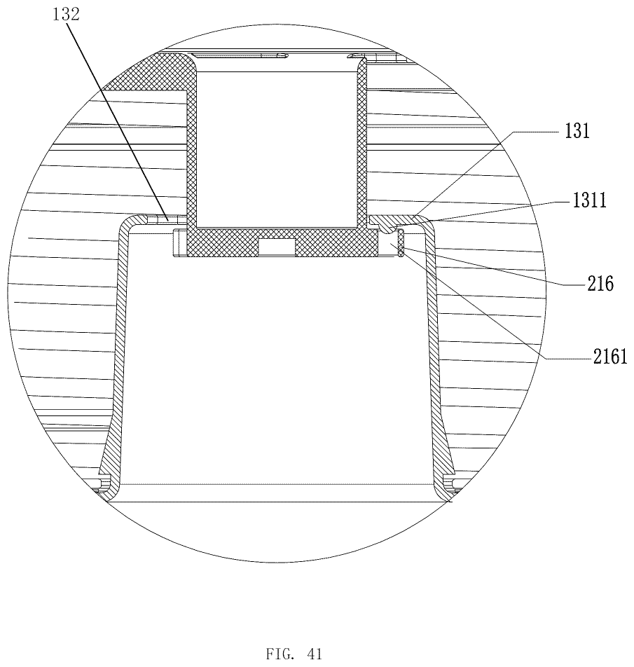

In order to enable a locked state to be more stable, referring to FIGS. 33-41, in this embodiment, a lower end surface of the upper cover 2 comprises a first protruding cavity structure 215 having a cylindrical shape along a compression direction of a spring module. An end surface of the first protruding cavity structure 215 extends away from a center of the first protruding cavity structure 215 to define first protruding edges 216 as the first locking structure 21, and the first protruding edges 216 are disposed at intervals.

An upper end surface of the base 1 comprises a second protruding cavity structure 13 having a cylindrical shape along the compression direction of the spring module. An upper end surface of the second protruding cavity structure 13 is a surface having an opening, and an inner wall of the surface having the opening extends towards a center of the second protruding cavity structure 13 to define second protruding edges 131 as the second locking structure 11. The second protruding edges 131 are disposed at intervals to form notches 132 between the second protruding edges 131 to enable the first protruding edges 216 to pass through.

Moreover, the first protruding edges 216 and the second protruding edges 131 respectively comprise one or more positioning grooves 2161 and one or more positioning protrusions 1311 that are configured for a positioning cooperation.

When the spring module needs to be locked in a compressed state, the upper cover 2 and the base 1 are held by both hands to compress the spring module by a force. At this time, the first protruding edges 216 enter the second protruding cavity structure 13 through the notches 132. At this time, the base 1 and the upper cover 2 rotate to perform a relative rotation of the base 1 and the upper cover 2. The first protruding edges 216 and the second protruding edges 131 can rotate from a staggered state to an aligned state, so that the first protruding edges 216 and the second protruding edges 131 can be buckled together in a direction for releasing the spring module, thereby locking the spring module in the compressed state. The spring modules in the compressed state are then stacked and loaded into the packaging box 6 for facilitating transportation. Moreover, when the first protruding edges 216 and the second protruding edges 131 rotate to the aligned state, the one or more positioning protrusions 1311 enter the one or more positioning grooves 2161 to achieve positioning. In this way, the spring module is fixed in the locked state, and if a rotational force applied on the spring module is not large enough, the one or more positioning protrusions 1311 cannot be separated from the one or more positioning grooves 2161. Therefore, the locked state is more stable.

When the spring module needs to be released for splicing, a relatively large force is applied to drive the base 1 and the upper cover 2 to rotate relative to each other, and a squeezing force generated between the one or more positioning protrusions 1311 and the one or more positioning grooves 2161 will drive the first protruding edges 216 and the second protruding edges 131 to deform in a direction away from each other, thereby causing the one or more positioning protrusions 1311 to be separated from the one or more positioning grooves 2161. The base 1 and the upper cover 2 can then rotate freely, so that the first protruding edges 216 and the second protruding edges 131 are in the staggered state again, and the first protruding edges 216 are removed from the notches 132 due to the elastic restoring force, thereby unlocking of the spring module.

### Embodiment 5

The unlocking of the spring module in Embodiments 3 and 4 requires two steps, that is, axial translation and circumferential rotation. Although these methods solve the problem of the locked state that is unstable in Embodiment 1, these methods also cause an operation for unlocking the spring module to be relatively complicated at the same time.

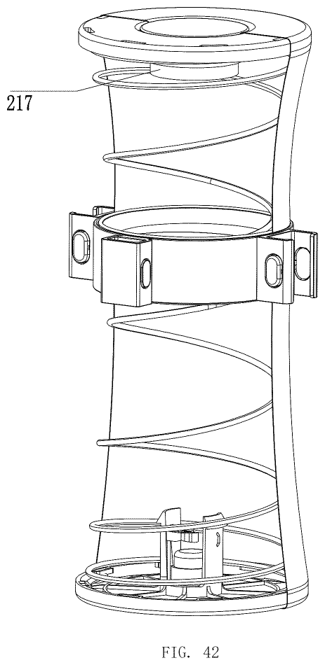

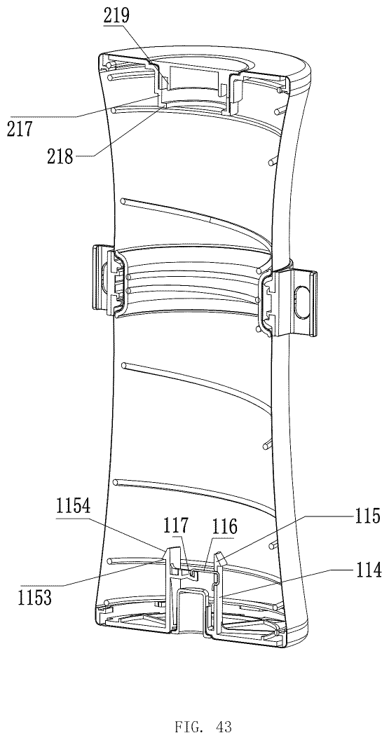

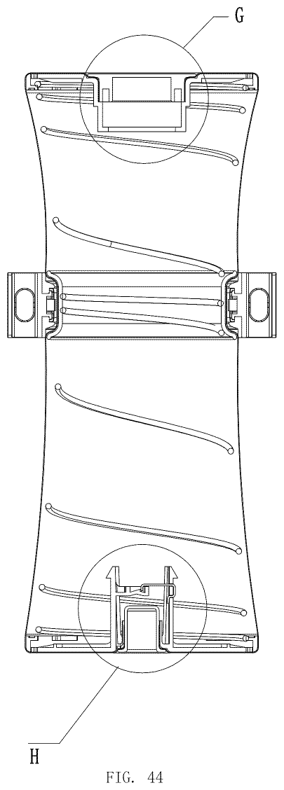

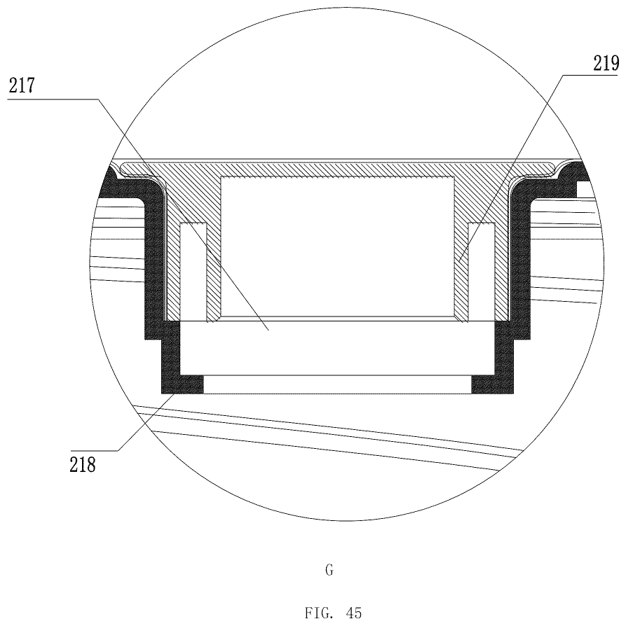

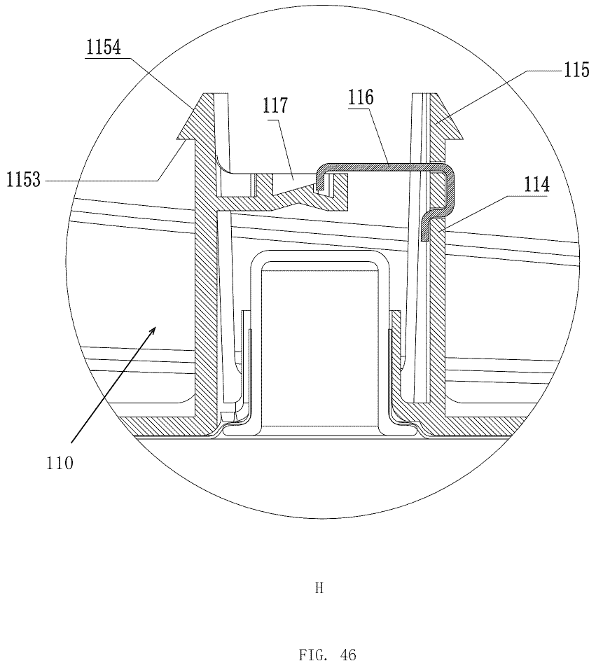

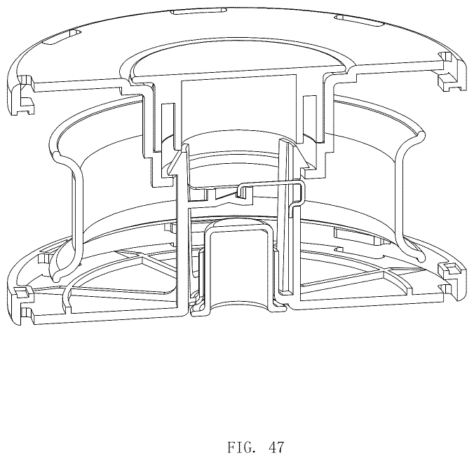

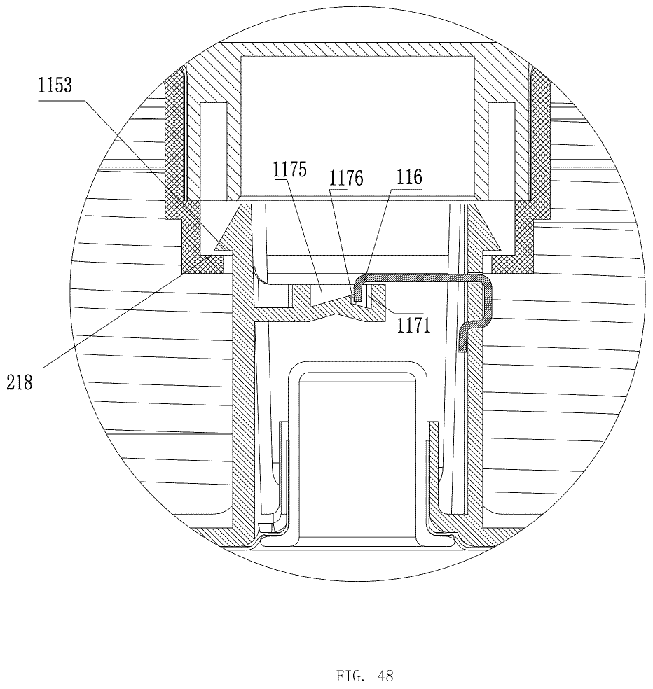

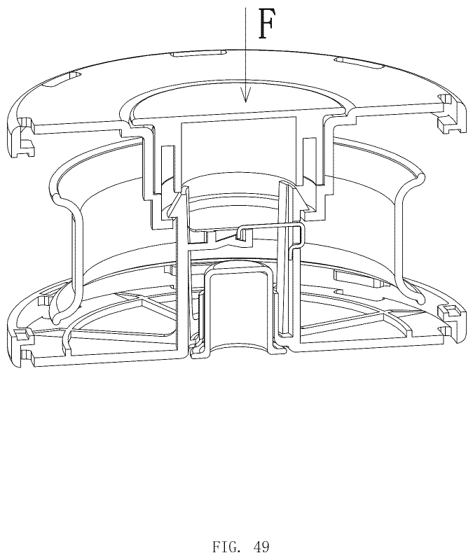

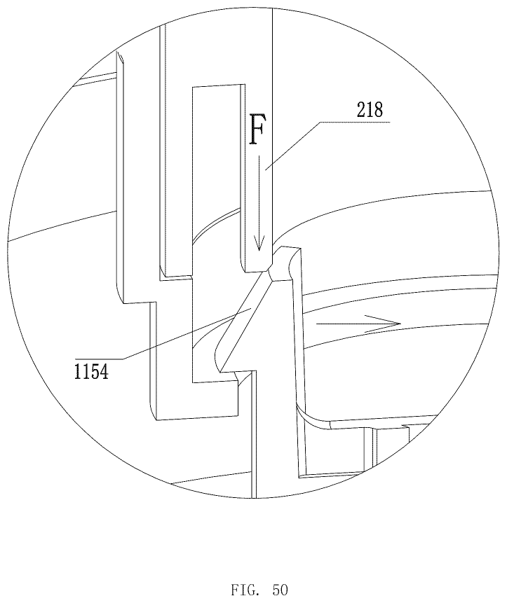

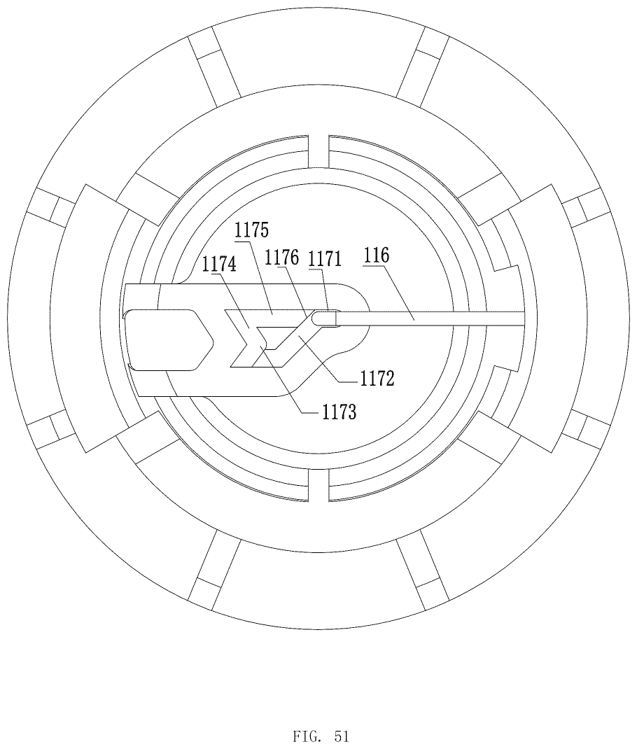

In order to simplify the operation for unlocking the spring module, this embodiment only adopts a method of the axial translation to unlock the spring module, and at the same time, a locked state can still be very stable. Referring to FIGS. 42-51, a lower end surface of the upper cover 2 comprises a protruding cavity structure 217 along a compression direction of the spring module. A top surface of the protruding cavity structure 217 is open, and an inner wall of the protruding cavity structure 217 forms a continuous protruding edge 218 as a first locking structure extending in a direction towards a center of the protruding cavity structure 217. An upper end surface of the base 1 comprises buckling hooks 110 as the second locking structure 11, first surfaces of the buckling hooks facing the base 1 define positioning surfaces 1153, and the buckling hooks 110 comprise connecting portions 114 and hook portions 115. The hook portions 115 are disposed on outer sides of the connecting portions 114. The hook portions 115 are gradually widened along the vertical downward direction, so that second surfaces of the hook portions 115 facing the upper cover 2 define inclined surfaces 1154.

Moreover, in this embodiment, the buckling hooks 110 are two buckling hooks 110, and opposite sides of the two buckling hooks 110 respectively comprise a pulling rib 116 and a guiding groove 117. A first end of the pulling rib 116 is used as a fixed end to be fixedly connected to a first one of the two buckling hooks, and a second end of the pulling rib 116 is used as a movable end to be disposed in the guiding groove 117. The guiding groove 117 comprises an initial position 1171, a first guiding surface 1172, a half-way position 1173, a second guiding surface 1174, and a third guiding surface 1175 arranged in sequence, and a distal end of the third guiding surface 1175 is in communication with the initial position 1171. An inner side of the guiding groove 117 comprises a one-way positioning surface 1176 disposed between the initial position 1171 and the third guiding surface 1175. The one-way positioning surface 1176 is used to limit a moving direction of the pulling rib 116 to enable the pulling rib 116 to enter into the initial position 1171 from the third guiding surface 1175 instead of entering into the third guiding surface 1175 from the initial position 1171.

When the two buckling hooks are respectively not subjected to external forces, the pulling rib 116 is located in the initial position 1171.

When the spring module needs to be locked in a compressed state, the upper cover 2 and the base 1 are held by both hands to compress the spring module by a force. At this time, the continuous protruding edge 218 on the upper cover 2 slides down along the inclined surfaces 1154 of the two buckling hooks. During this process, the two buckling hooks deform inwardly due to a squeezing force, causing the pulling rib 116 to move within the guiding groove 117. Moreover, due to an existence of the one-way positioning surface 1176, the pulling rib 116 can only enter the first guiding surface 1172 from the initial position 1171, move along the first guiding surface 1172, and finally fall into the half-way position 1173. The spring module is then continually pressed, and the pulling rib 116 will then move along the second guiding surface 1174. When entering the third guiding surface 1175, the squeezing force between the inclined surfaces 1154 and the continuous protruding edge 218 disappears, and the pulling rib 116 will move to the initial position 1171 along the third guiding surface 1175 due to a restoring force. At this time, the two buckling hooks have also reset to initial positions, so that the continuous protruding edge 218 is buckled to the positioning surfaces 1153 of the buckling hooks along a direction for releasing the spring module, thereby locking the spring module in the compressed state. The spring modules in the compressed state are then stacked and loaded into the packaging box 6 for facilitating transportation.

In this embodiment, the protruding cavity structure 217 forms a pushing portion 219 having a diameter that is smaller than that of the continuous protruding edge 218 and located on an upper side of the continuous protruding edge 218. When the spring module needs to be released, the spring module is pressed again, and the pushing portion 219 pushes the two buckling hooks along the inclined surfaces 1154 to contract inward in a horizontal direction, causing the pulling rib 116 to repeat the aforementioned movement process again, and the two buckling hooks are finally separated from the positioning surfaces 1153 to release the spring module.

It can be seen from the aforementioned process that whether the spring module is compressed or the spring module is released, the spring module only needs to be pressed. In this way, if a pressing force is canceled midway, the pulling rib 116 will be fixed at a current position in the guiding groove 117 instead of continuing to move, so that incorrect releasing of the entire spring module due to an operational mistake will not occur.

In this embodiment, the first guiding surface 1172 and the second guiding surface 1174 are inclined surfaces, and the third guiding surface 1175 is a straight surface. A circular arc-shaped transition is disposed between the first guiding surface 1172 and the half-way position 1173. The one-way positioning surface 1176 is a protrusion located at a bottom of the initial position 1171, and a bottom surface of the third guiding surface 1175 is an inclined surface. Therefore, the pulling rib 116 is blocked by the protrusion when moving from the initial position 1171 to the third guiding surface 1175. However, during a movement from the third guiding surface 1175 to the initial position 1171, as the bottom surface of the third guiding surface 1175 is the inclined surface, the pulling rib 116 will rise accordingly until entering into the initial position 1171 by passing over the protrusion during the movement.

The aforementioned embodiments are merely some preferred embodiments of the present disclosure, and the design and the concept of the disclosure is not limited thereto. Thus, it is intended that the present disclosure cover non-substantive modifications of the present disclosure provided they are made based on the concept within the technical scope disclosed in the present disclosure by any technical person familiar with skill in the art.

What is claimed is:

1. A spring module configured to be compressed for storage, comprising:
a spring,
an upper cover disposed on an upper end of the spring, and
a base disposed on a lower end of the spring, wherein:
the upper cover extends downward to define a first locking structure,
the base extends upward to define a second locking structure,
the spring is compressed to a locked position along an axial direction of the spring by an external force,
the first locking structure and the second locking structure in the locked position are buckled together, and
the first locking structure and the second locking structure in a locked state move relative to each other in a circumferential direction of the spring to release from being buckled together.

2. The spring module configured to be compressed for the storage according to claim 1, wherein:
an upper end surface of the base comprises a protruding cavity structure along a compression direction of the spring module,
an outer edge of the protruding cavity structure comprises protruding edges, which are discontinuous, as the second locking structure,
adjacent protruding edges of the protruding edges define gaps,
a lower end surface of the upper cover comprises buckling hooks corresponding to the protruding edges one to one and disposed at intervals,
the buckling hooks are used as the first locking structure,
first surfaces of the protruding edges facing the base define positioning surfaces,
an opposite movement of the buckling hooks and the protruding edges along the axial direction of the spring enables the buckling hooks to be buckled to the positioning surfaces of the protruding edges so as to be buckled together in a direction opposite to the opposite movement to achieve buckling together, and
the buckling hooks and the protruding edges move relative to each other along the circumferential direction of the spring to enable the buckling hooks to reach the gaps to release from the buckling together.

3. The spring module configured to be compressed for the storage according to claim 2, wherein:
the protruding edges are gradually widened in a vertical downward direction, so that second surfaces of the protruding edges facing the upper cover define inclined surfaces,
the buckling hooks comprise connecting portions and hook portions,
first ends of the connecting portions are connected to the lower end surface of the upper cover,
the hook portions are disposed on inner sides of the connecting portions and face a center of the protruding cavity structure, and
the spring module is compressed to enable the hook portions to slide along the inclined surfaces of the protruding edges until the buckling hooks are buckled to the positioning surfaces to enable the buckling hooks to be buckled to the positioning surfaces.

4. The spring module configured to be compressed for the storage according to claim 2, wherein:
the protruding cavity structure comprises multiple layers of the protruding edges, which are discontinuous, along a vertical direction, and
each of the multiple layers of the protruding edges is arranged at a same position on a circumference of the protruding cavity structure.

5. A spring module configured to be compressed for storage, comprising:
a spring,
an upper cover disposed on an upper end of the spring,
a base disposed on a lower end of the spring, and
a releasing member, wherein:
the upper cover extends downward to define a first locking structure,
the base extends upward to define a second locking structure,
the spring is compressed to a locked position by an external force along an axial direction of the spring,
the first locking structure and the second locking structure in the locked position are buckled together, and
the releasing member is configured to drive a relative movement of the first locking structure and the second locking structure in a locked state in a radial direction of the spring to release the first locking structure and the second locking structure from buckling together.

6. The spring module configured to be compressed for the storage according to claim 5, wherein:
an upper end surface of the base comprises a protruding cavity structure along a compression direction of the spring module,
an outer edge of the protruding cavity structure comprises a protruding edge, which is continuous, as the second locking structure,
a closing plug, used as the releasing member, is separably disposed in the protruding cavity structure and push the protruding edge to move relative to the first locking structure in the radial direction of the spring,
a lower end surface of the upper cover comprises buckling hooks disposed at intervals and used as the first locking structure,
a first surface of the protruding edge facing the base defines a positioning surface,
an opposite movement of the buckling hooks and the protruding edge along the axial direction of the spring enables the buckling hooks to be buckled to the positioning surface of the protruding edge so as to be buckled together in a direction opposite to the opposite movement to achieve the buckling together,
the closing plug is taken out to enable the protruding edge to contract in the radial direction of the spring relative to the buckling hooks, and
the buckling hooks are separated from the protruding edge to release the buckling together.

7. A spring module configured to be compressed for storage, comprising:
a spring,
an upper cover disposed on an upper end of the spring, and
a base disposed on a lower end of the spring, wherein:
the upper cover extends downward to define a first locking structure,
the base extends upward to define a second locking structure,
the spring is compressed to a locked position by an external force along an axial direction of the spring,
the first locking structure and the second locking structure in the locked position are buckled together, and
the first locking structure and the second locking structure in a locked state firstly move in the axial direction of the spring and then move in a circumferential direction of the spring relative to each other to release from buckling together by the external force.

8. The spring module configured to be compressed for the storage according to claim 7, wherein:
a lower end surface of the upper cover comprises a protruding cavity structure along a compression direction of the spring module,
an inner wall of the protruding cavity structure extends towards a center of the protruding cavity structure to define protruding edges as the first locking structure,
the protruding edges are disposed at intervals,
gaps are defined between the protruding edges,
an upper end surface of the base comprises buckling hooks corresponding to the protruding edges one-to-one and disposed at intervals,
the buckling hooks are used as the second locking structure,
first surfaces of the buckling hooks facing the base define positioning surfaces,
an opposite movement of the buckling hooks and the protruding edges along the axial direction of the spring enables the protruding edges to be buckled to the positioning surfaces of the buckling hooks so as to be buckled together in a direction opposite to the opposite movement to achieve the buckling together,
two sides of each of the protruding edges along a circumferential direction of the protruding cavity structure are respectively disposed with a first positioning wall and a second positioning wall located on the inner wall of the protruding cavity structure,
an upper end surface of the first positioning wall is lower than an upper end surface of the second positioning wall, and
the buckling hooks move in the axial direction of the spring and the circumferential direction of the spring relative to the protruding edges to reach the gaps to release from the buckling together by passing over the first positioning wall.

9. The spring module configured to be compressed for the storage according to claim 8, wherein:
a lower end surface of the first positioning wall is higher than a lower end surface of the second positioning wall,
the lower end surface of the second positioning wall extends to a lower end surface of the protruding cavity structure, and
a guiding inclined surface is connected to and disposed between the lower end surface of the first positioning wall and the lower end surface of the second positioning wall.

10. The spring module configured to be compressed for the storage according to claim 8, wherein:
a closing plug is separably disposed in a middle portion of the buckling hooks of the base,
the closing plug is configured to push the buckling hooks to move in a radial direction of the spring, and
when the closing plug is taken out:
the buckling hooks contract in the radial direction of the spring relative to the protruding edges, and
the buckling hooks are separated from the protruding edges to release the buckling together.

11. A spring module configured to be compressed for storage, comprising:
a spring,
an upper cover disposed on an upper end of the spring, and
a base disposed on a lower end of the spring, wherein:
the upper cover extends downward to define a first locking structure,
the base extends upward to define a second locking structure,
the spring is compressed to a locked position by an external force along an axial direction of the spring, and
when the spring is in the locked position, the first locking structure and the second locking structure move relative to each other in a circumferential direction of the spring by the external force, so that the first locking structure and the second locking structure are alternatively converted between a buckled state and an unbuckled state.

12. The spring module configured to be compressed for the storage according to claim 11, wherein:
a lower end surface of the upper cover comprises a first protruding cavity structure along a compression direction of the spring module,
an end surface of the first protruding cavity structure comprises first protruding edges extending away from a center of the first protruding cavity structure,
the first protruding edges are used as the first locking structure,
the first protruding edges are disposed at intervals,
an upper end surface of the base comprises a second protruding cavity structure along the compression direction of the spring module,
an upper end surface of the second protruding cavity structure comprises a surface having an opening,
an inner wall of the surface having the opening comprises second protruding edges extending towards a center of the second protruding cavity structure,
the second protruding edges are used as the second locking structure,
the second protruding edges are disposed at intervals,
adjacent second protruding edges of the second protruding edges form gaps configured to enable the first protruding edges to pass through,
after the first protruding edges are buckled to the second protruding cavity structure, the first protruding edges move relative to the second protruding edges in the circumferential direction of the spring enables the first protruding edges to be aligned with the second protruding edges, and
the first protruding edges and the second protruding edges are buckled together in a direction opposite to an axial opposite movement to achieve buckling together.

13. The spring module configured to be compressed for the storage according to claim 12, wherein:
the first protruding edges and the second protruding edges move relative to each other in the circumferential direction of the spring to enable the first protruding edges to approach the gaps to release the second protruding edges from the buckling together.

14. The spring module configured to be compressed for the storage according to claim 12, wherein:
the first protruding edges and the second protruding edges respectively comprise one or more positioning grooves and one or more positioning protrusions for positioning cooperation.

15. A spring module configured to be compressed for storage, comprising:
a spring,
an upper cover disposed on an upper end of the spring, and
a base disposed on a lower end of the spring, wherein:
the upper cover extends downward to define a first locking structure,
the base extends upward to define a second locking structure,
the spring is compressed to a locked position by an external force along an axial direction of the spring,
the first locking structure and the second locking structure in the locked position are buckled together, and
the first locking structure and the second locking structure in a locked state move in the axial direction of the spring to release from buckling together by the external force.

16. The spring module configured to be compressed for the storage according to claim 15, wherein:
a lower end surface of the upper cover comprises a protruding cavity structure along a compression direction of the spring module,
a top surface of the protruding cavity structure is open,
an inner wall of the protruding cavity structure comprises a protruding edge, which is continuous, extending in a direction towards a center of the protruding cavity structure,
the protruding edge is used as the first locking structure,
an upper end surface of the base comprises buckling hooks as the second locking structure,
first surfaces of the buckling hooks facing the base define positioning surfaces,
an axial opposite movement of the protruding edge and the buckling hooks enables the protruding edge to be buckled to the positioning surfaces in a direction opposite to the axial opposite movement to achieve the buckling together,
the buckling hooks have elasticity for contracting in a horizontal direction,
the protruding cavity structure defines a pushing portion located on an upper side of the protruding edge, and
the pushing portion moves in the axial direction of the spring to push the buckling hooks to contract inward in the horizontal direction, causing the buckling hooks and the protruding edge to be separated from each other to release from the buckling together.

17. The spring module configured to be compressed for the storage according to claim 16, wherein:
the buckling hooks are two buckling hooks,
opposite sides of the two buckling hooks respectively comprise a pulling rib and a guiding groove,
a first end of the pulling rib is used as a fixed end with a first one of the two buckling hooks,
a second end of the pulling rib is disposed in the guiding groove used as a movable end, and
the movable end moves in the guiding groove due to a compressing force for compressing the spring module.

18. The spring module configured to be compressed for the storage according to claim 17, wherein:
the guiding groove comprises an initial position, a first guiding surface, a half-way position, a second guiding surface, and a third guiding surface arranged in sequence,
a distal end of the third guiding surface is in communication with the initial position,
a one-way positioning surface is disposed between the initial position and the third guiding surface to enable the pulling rib to unidirectionally enter into the initial position from the third guiding surface, and
the movable end is configured to stay at the initial position or the half-way position.

19. An elastic module, comprising:
multiple of the spring modules configured to be compressed for the storage according to claim 1, wherein:
the multiple of the spring modules are connected through a connecting member of each of the multiple of the spring modules to form the elastic module.

20. An elastic mattress, wherein the elastic mattress comprises the elastic module according to claim 19.
